(19) United States
(12) Patent Application Publication
(10) Pub. No.: US 2026/0223268 A1
(43) Pub. Date: Jul. 30, 2026

(54) DISPLAY SYSTEM AND METHOD

(71) Applicant: SIGNIFY HOLDING B.V., EINDHOVEN (NL)

(72) Inventors: TOBIAS GEORG TOLLE, BEERSE (BE); ROBERTUS ADRIANUS GERARDUS HENRICUS VAN GESTEL, TILBURG (NL); LEENDERT TEUNIS ROZENDAAL, VALKENSWAARD (NL)

(21) Appl. No.: 19/148,752

(22) PCT Filed: Jan. 11, 2024
(86) PCT No.: PCT/EP2024/050586

§ 371 Date: Jul. 17, 2025

(30) Foreign Application Priority Data
Jan. 17, 2023 (EP) 23151886.1

(51) Int. Cl. H05B 47/155; H05B 45/10; H05B 45/20

(52) U.S. Cl. CPC H05B 47/155; H05B 45/10; H05B 45/20

(57) ABSTRACT

There is provided a display system (100) and a method (800). The display system comprises a screen (110) with screen part(s) (120a-c) comprising a plurality of sub-areas (130a-c). The display system further comprises a screen controller (150) coupled to the screen, light source(s) (200a-c) associated with a respective screen part, a controller (300) coupled to the light source(s), and an input coupled to the controller and configured to receive information from a user. The screen controller is configured to control each sub-area to display light with a respective intensity (I_{i,j}) and a color (Cⱼ). The input is configured to receive information of a selection of one sub-area. The controller is further configured to control the light source(s) based on the intensity (I_{i,j}) and the color (Cⱼ) of the displayed light of the selected sub-area.

### FIELD OF THE INVENTION

The present invention generally relates to the field of lighting associated with entertainment devices or systems. More specifically, the present invention relates to a display system in which one or more lighting properties of a screen may match one or more properties of lighting in area(s) around the screen.

### BACKGROUND OF THE INVENTION

In recent years, so-called Ambilight TVs have been introduced to the market. TVs of this kind include light sources arranged at the periphery of the TVs, wherein the light sources emit ambience light onto the wall behind the TVs such that the emitted light matches the content being shown. The obtained effect is a larger virtual screen and an improved viewing experience. Philips' Hue Entertainment and Hue Sync have become very popular among owners of Philips Hue lights. Philips Hue Sync enables the rendering of light effects based on the content that is played on a computer, e.g. video games. Such a dynamic lighting system can dramatically influence the experience and impression of audio-visual material.

For an optimal entertainment lighting experience, it is desirable that the light effects are tuneable in order to obtain the TV/surrounding area matching. A mismatch can occur due to one or more lighting properties, light surrounding properties (e.g. coloured walls, varying reflectivity of walls), light source setup (e.g. distance between the light source(s) and wall, direction of light), properties of the TV (e.g. technology like e.g. LCD or plasma, color optimization algorithms, user settings, etc.), other light in the area (artificial or natural), etc.

However, there is presently no convenient, efficient and/or non-complex system and/or method for users/consumers to perform a tuning of the light for entertainment devices or systems comprising screens (such as TVs, TV systems, monitors, etc.). For example, an automatic tuning based on the analysis of a picture or movie recorded by a handheld device such as a (smart) phone (that shows the TV screen and the surrounding light effects) is very difficult to implement. The reasons for the implementation difficulty are, for example, due to the large variety of entertainment setups, lighting conditions, the difficulty of a camera to take a picture of the self-illuminated TV screen and the light sources surrounding it (a typical phone camera may be oversaturated with such light levels), the processing power of phones, the variety of phones and cameras, the lack of suitable algorithms, etc.

Hence, there is a wish to provide a system and/or a method which is (are) able to provide a tuning of the light for entertainment devices or systems comprising screens in a convenient, efficient and/or non-complex manner for a user/consumer.

### SUMMARY OF THE INVENTION

It is an object of the present invention to mitigate the above problems and to provide a system and a method whereby a user/consumer may achieve a tuning of the light for entertainment devices or systems comprising screens in a convenient, efficient and/or non-complex manner.

This and other objects are achieved by providing a display system and a method having the features in the independent claims. Preferred embodiments are defined in the dependent claims.

Hence, according to a first aspect of the present invention, there is provided a display system. The display system comprises a screen comprising at least one screen part, the at least one screen part comprising a plurality of sub-areas, a screen controller coupled to the screen, at least one light source arranged to emit light, the at least one light source being associated with the at least one screen part, a controller configured to control the at least one light source, and an input coupled to the controller and configured to receive information from a user. The screen controller is configured to control each sub-area of the plurality of sub-areas to display light having a respective intensity, I_{i,j}, and/or a respective color, C_{i,j}, the controller being configured to control the at least one light source associated with the at least one screen part such that the emitted light from the at least one light source has an intensity, Iⱼ, and/or a color, Cⱼ, the input being configured to receive information of a first selection of one sub-area of the plurality of sub-areas based on a level of correspondence between the intensity of the displayed light of the sub-area and the intensity of the emitted light from the at least one light source, and/or of a second selection of one sub-area of the plurality of sub-areas based on a level of correspondence between the color of the displayed light of the sub-area and the color of the emitted light from the at least one light source, and the controller further being configured to subsequently control the at least one light source based on the intensity, I_{i,j}, of the displayed light of the sub-area selected according to the first selection and/or the color, C_{i,j}, of the displayed light of the sub-area selected according to the second selection.

The display system comprises a screen comprising at least one screen part, wherein each screen part of the at least one screen part comprises a plurality of sub-areas. The display system further comprises a screen controller coupled to the screen and may further comprise at least one set of at least one light source arranged to emit light, wherein each set of at least one light source is associated with a respective screen part. The display system further comprises a controller coupled to the at least one set of at least one light source and configured to control the at least one set of at least one light source, and an input coupled to the controller and configured to receive information from a user.

For each screen part of the plurality of screen parts, the screen controller may be configured to control each sub-area of the plurality of sub-areas to display light with a respective intensity, I_{i,j}, within an intensity interval, IPⱼ, wherein the respective intensity, I_{i,j}, may be different from an intensity of the displayed light of at least one other sub-area of the screen part, the controller being configured to control the set of at least one light source associated with the screen part such that the emitted light from the set of at least one light source has an intensity, Iⱼ, the input being configured to receive information of a first selection of one sub-area of the plurality of sub-areas based on a level of correspondence between the displayed light of the sub-area and the emitted light from the set of at least one light source, wherein the controller is further configured to control the set of at least one light source based on the intensity, I_{i,j}, of the displayed light of the sub-area selected according to the first selection, and/or the screen controller may be configured to control each sub-area of the plurality of sub-areas to display light in a color, C_{i,j}, within a color interval, CPⱼ, wherein the respective color, C_{i,j}, may be different from a color of the displayed light of at least one other sub-area of the screen part, the controller being configured to control the set of at least one light source associated with the screen part such that the emitted light from the set of at least one light source has a color, Cⱼ, the input being configured to receive information of a second selection of one sub-area of the plurality of sub-areas based on a level of correspondence between the displayed light of the sub-area and the emitted light from the set of at least one light source, wherein the controller is further configured to control the set of at least one light source based on the color, C_{i,j}, of the displayed light of the sub-area selected according to the second selection.

According to a second aspect of the present invention, there is provided a method for light source control via a display system. The display system comprises a screen comprising at least one screen part, the at least one screen part comprising a plurality of sub-areas, at least one light source arranged to emit light, the at least one light source being associated with the at least one screen part. The method comprises controlling each sub-area of the plurality of sub-areas to display light with a respective intensity, I_{i,j}, and/or controlling each sub-area of the plurality of sub-areas to display light in a color, C_{i,j}, controlling the at least one light source associated with the screen part such that the emitted light from the set of at least one light source has an intensity, Iⱼ, and/or a color, Cⱼ, receiving information from a user of a first selection of one sub-area of the plurality of sub-areas based on a level of correspondence between the displayed light of the sub-area and the emitted light from the at least one light source, and/or receiving information from a user of a second selection of one sub-area of the plurality of sub-areas based on a level of correspondence between the displayed light of the sub-area and the emitted light from the set of at least one light source, and subsequently controlling the at least one light source based on the intensity, I_{i,j}, of the displayed light of the sub-area selected according to the first selection, and/or based on the color, C_{i,j}, of the displayed light of the sub-area selected according to the second selection.

The display system comprises a screen comprising at least one screen part, wherein each screen part of the at least one screen part comprises a plurality of sub-areas, may comprise at least one set of at least one light source arranged to emit light, wherein each set of at least one light source is associated with a respective screen part. For each screen part of the plurality of screen parts, the method may comprise the step of controlling each sub-area of the plurality of sub-areas to display light with a respective intensity, I_{i,j}, within an intensity interval, IPⱼ, wherein the respective intensity, I_{i,j}, is different from an intensity of the displayed light of at least one other sub-area of the screen part.

The method may further comprise the step of controlling the set of at least one light source associated with the screen part such that the emitted light from the set of at least one light source has an intensity, Iⱼ. The method may further comprise the step of receiving information from a user of a first selection of one sub-area of the plurality of sub-areas based on a level of correspondence between the displayed light of the sub-area and the emitted light from the set of at least one light source. The method may further comprise the step of controlling the set of at least one light source based on the intensity, I_{i,j}, of the displayed light of the sub-area selected according to the first selection. The method may further comprise the step of controlling each sub-area of the plurality of sub-areas to display light in a color, C_{i,j}, within a color interval, CPⱼ, wherein the respective color, C_{i,j}, is different from a color of the displayed light of at least one other sub-area of the screen part. The method may further comprise the step of controlling the set of at least one light source associated with the screen part such that the emitted light from the set of at least one light source has a color, Cⱼ. The method may further comprise the step of receiving information from a user of a second selection of one sub-area of the plurality of sub-areas based on a level of correspondence between the displayed light of the sub-area and the emitted light from the set of at least one light source. The method may further comprise the step of controlling the set of at least one light source based on the color, C_{i,j}, of the displayed light of the sub-area selected according to the second selection.

Thus, the present invention according to the first aspect is based on the idea of providing a display system which provides the possibility for a user/consumer to select the sub-area of the screen which best matches the light from the associated set of light source(s), leading to an improved user experience. In other words, a user may choose an optimal (the best/preferred) match between the intensity and/or color of the sub-areas of the screen and the light from the associated set of light source(s), and perform this for different light areas around the screen corresponding to the respective screen parts. Hence, for an optimal entertainment lighting experience, the present invention provides a tuning of the light effects so that the lighting color and/or intensity of the surrounding area around the screen match the colour hue and/or intensity on the screen. Furthermore, it should be noted that during operation of the display system, the lights are tuned so that the surrounding environment (e.g. one or more walls) may reflect the intensity/color combination that matches the screen part. The display system of the present invention allows the tuning as described above to be performed in a convenient, efficient and/or non-complex manner.

The present invention has numerous advantages compared to solutions implemented in, and/or suggested by, the prior art. The present invention is advantageous compared to arrangements wherein property(ies) such as e.g. color(s) and/or intensity(ies) are shown on a handheld device (e.g. a mobile (smart) phone) and a user should select the property(ies) from the handheld device, as the property(ies) may appear differently on the device than on the screen. The present invention is further advantageous in that the display system may compensate for mixing of the displayed light with other light sources and/or for the displayed light shining on (a) reflective, colored and/or diffuse surface(s). Furthermore, as the screen of the display system is arranged to show multiple intensity/color sub-areas at the same time, the present invention is advantageous in that it provides an easier selection process for the user compared to an (iterative) selection of intensity/brightness values/settings of the lamp.

It will be appreciated that the mentioned advantages of the display system arrangement of the first aspect of the present invention also hold for the method according to the second aspect of the present invention.

Hence, according to a first aspect of the present invention, there is provided a display system. The display system comprises a screen. By the term “screen”, it is here meant substantially any screen, display, monitor, etc., such as a TV screen, computer screen/monitor, or the like. The screen comprises at least one screen part, wherein each screen part of the at least one screen part comprises a plurality of sub-areas. Hence, the screen is divided into one or more parts which in turn is (are) divided into a plurality of sub-areas. The display system further comprises a screen controller coupled to the screen. By “screen controller”, it is here meant substantially any controller, control unit (device), or the like, which is able to control one or more properties of the screen. The display system comprises at least one set of at least one light source arranged to emit light, wherein each set of at least one light source is associated with a respective screen part. Hence, each set of light source(s) is associated or linked with a respective screen part. The display system further comprises a controller coupled to the at least one set of at least one light source and configured to control the at least one set of at least one light source. Hence, the controller (e.g. control unit) is arranged or configured to control the set(s) of light source(s). The display system further comprises an input coupled to the controller and configured to receive information from a user. Hence, a user may provide information to the input, and the controller may use the information for control purposes.

In the following, the screen controller, controller and input of the display system are configured to perform the described actions for each screen part of the plurality of screen parts. The screen controller is configured to control each sub-area of the plurality of sub-areas to display light with a respective intensity, I_{i,j}, which may be within an intensity interval, IPⱼ, wherein the respective intensity, I_{i,j}, may be different from an intensity of the displayed light of at least one other sub-area of the screen part. Hence, the screen controller is configured to control the sub-areas such that the sub-areas display light with (individually) different intensities, I_{i,j}, which all may be within the intensity interval, IPⱼ. The controller is configured to control the set of at least one light source associated with the screen part such that the emitted light from set of at least one light source has an intensity, Iⱼ. Hence, the controller is configured to control the set of light source(s) such that the emitted light from the set has an intensity, Iⱼ, which, for example, may be within the (same) intensity interval, IPⱼ, as the intensities, I_{i,j}, of the displayed light via the screen controller. The input is configured to receive information of a first selection of one sub-area of the plurality of sub-areas based on a level of correspondence between the displayed light of the sub-area and the emitted light from the set of at least one light source. Hence, the level of correspondence between the displayed light of the sub-area and the emitted light from the set of light source(s) relates to a matching regarding intensity between the displayed light of the sub-area and the emitted light from the set of light source(s) and the user's (first) selection of the sub-area based on this level of correspondence or matching. In other words, if the user determines a relatively high level of correspondence (such as a relatively close match, or even perfect match) between the intensity of the displayed light of the sub-area and the intensity of the emitted light from the set of light source(s), the user may select this specific sub-area and the input may accordingly receive this information. The controller is further configured to control the set of at least one light source based on the intensity, I_{i,j}, of the displayed light of the sub-area selected according to the first selection. Hence, the controller is configured to control the set of light source(s) based on the intensity, I_{i,j}, of the displayed light of the sub-area selected according to the first selection by the user when determining the highest level of (best) correspondence/matching between the displayed light of the sub-area and the emitted light from the set of light source(s).

The screen controller is configured to control each sub-area of the plurality of sub-areas to display light in a color, C_{i,j}, which may be within a color interval, CPⱼ, wherein the respective color, C_{i,j}, may be different from a color of the displayed light of at least one other sub-area of the screen part. Hence, the screen controller is configured to control the sub-areas such that the sub-areas may display light with (individually) different colors, C_{i,j}. The controller is configured to control the set of at least one light source associated with the screen part such that the emitted light from the set of at least one light source has a color, Cⱼ. Hence, the controller is configured to control the set of light source(s) such that the emitted light from the set has a (second) color, Cⱼ, which, for example, may be within the (same) color interval, CPⱼ, as the (first) colors, C_{i,j}, of the displayed light via the screen controller. The input is configured to receive information of a second selection of one sub-area of the plurality of sub-areas based on a level of correspondence between the displayed light of the sub-area and the emitted light from the set of at least one light source. Hence, the level of correspondence between the displayed light of the sub-area and the emitted light from the set of light source(s) relates to a color matching between the displayed light of the sub-area and the emitted light from the set of light source(s) and the user's (second) selection of the sub-area based on this level of correspondence or matching. In other words, if the user determines a relatively high level of correspondence (such as a relatively close match, or even perfect match) between the color of the displayed light of the sub-area and the color of the emitted light from the set of light source(s), the user may select this specific sub-area and the input may accordingly receive this information. The controller is further configured to control the set of at least one light source based on the color, C_{i,j}, of the displayed light of the sub-area selected according to the second selection. Hence, the controller is configured to control the set of light source(s) based on the color, C_{i,j}, of the displayed light of the sub-area selected according to the second selection by the user when determining the highest level of (best) correspondence/matching between the displayed light of the sub-area and the emitted light from the set of light source(s).

According to an embodiment of the present invention, each sub-area of the plurality of sub-areas may be associated with an identification label, ID_{L}, wherein each identification label, ID_{L}, is arranged to be displayed on the respective sub-area. Hence, each identification label, ID_{L}, may be visually displayed on the screen (parts) for identification by a user. The present embodiment is advantageous in that the user may conveniently identify which sub-area of the plurality of sub-areas to select with respect to intensity and/or color.

According to an embodiment of the present invention, the screen controller may be configured to simultaneously control each sub-area of the plurality of sub-areas to display light with at least one of the respective intensity, I_{i,j}, and the color, C_{i,j}. Hence, the screen controller may display light of all sub-areas at the same time. The present embodiment is advantageous in that the user may compare the light settings for all sub-areas and make his/her first and second selections accordingly, which may lead to improved (more accurate) selections.

According to an embodiment of the present invention, the screen controller may be configured to control each sub-area of the plurality of sub-areas to display light with at least one of the respective intensity, I_{i,j}, and the color, C_{i,j}, in sequence. Hence, the screen controller may display light in the sub-areas in sequence for the first and second selections by the user. The present embodiment is advantageous in that the user may prefer to be able to focus on one sub-area at a time. Furthermore, as a user may (subconsciously) be affected by displayed light of neighboring sub-areas, the present embodiment may generate improved user selections.

According to an embodiment of the present invention, the screen controller may be further configured to, for a plurality of iterations m=1 . . . p, wherein p is an integer ≥1, control each sub-area of the plurality of sub-areas to display light in a color, C_{i,j}, within a color interval, CPⱼ, dependent on the preceding second selection wherein the respective color, C_{i,j}, is different from a color of the displayed light of at least one other sub-area of the screen part, wherein the controller is further configured to control the set of at least one light source based on the color, C_{i,j}, of the displayed light of the sub-area selected according to the p^{th} second selection. In other words, the present embodiment represents an iterative control by the screen controller based on one or more preceding second selections of the user regarding the level of correspondence/matching between the color, C_{i,j}, of the displayed light of the sub-area and the emitted light from the set of light source(s). The present embodiment is advantageous in that the screen controller may efficiently and rapidly control the color(s), C_{i,j}, and color interval(s), CPⱼ, according to the user's second selections, which accordingly leads to a relatively fast, efficient and/or precise convergence to the color correspondence/matching. For example, in case a user selects a (first) color, C_{i,j}, the screen controller may accordingly narrow a subsequent color interval, CPⱼ, and display (second) colors, C_{i,j}, from which the user may make a selection, and so on, until a satisfactory selection is done.

According to an embodiment of the present invention, the screen controller may be further configured to, for a plurality of iterations k=1 . . . n, wherein n is an integer ≥1, control each sub-area of the plurality of sub-areas to display light with a respective intensity, I_{i,j}, within a k^{th} intensity interval, IPⱼ, wherein the respective intensity, I_{i,j}, is different from an intensity of the displayed light of at least one other sub-area of the screen part, the controller being configured to control the set of at least one light source associated with the screen part such that the emitted light from the set of at least one light source has a k^{th} intensity, Iⱼ. Hence, compared to the embodiment of displaying (only) one (single) intensity interval, IPⱼ, from which the input receives information of a first selection from a user of the intensity, I_{i,j}, of the displayed light of the sub-area, the screen controller may according to this embodiment iteratively display light within different intensity intervals, IPⱼ. After the (final, k=n) kₜₕ iteration, the controller may control the set of light source(s) to emit light with a k^{th} intensity, Iⱼ. By the display system's repetition of the tuning process for different intensity intervals, IPⱼ, the present embodiment is advantageous in that compensation may be provided for one or more settings and/or properties of the screen of the display system.

According to an embodiment of the present invention, the screen controller may be further configured to, for a plurality of iterations s=1 . . . t, wherein t is an integer ≥1, control each sub-area of the plurality of sub-areas to display light in a color, C_{i,j} within a s^{th} color interval, CPⱼ, wherein the respective color, C_{i,j}, is different from a color of the displayed light of at least one other sub-area of the screen part, the controller being configured to control the set of at least one light source associated with the screen part such that the emitted light from the set of at least one light source has a s^{th} color, Cⱼ. Hence, compared to the embodiment of displaying (only) one (single) color interval, CPⱼ, from which the input receives information of a second selection from a user of the color, C_{i,j}, of the displayed light of the sub-area, the screen controller may according to this embodiment iteratively display light within different color intervals, CPⱼ. After the (final, s=t) s^{th} iteration, the controller may control the set of light source(s) to emit light with a s^{th} color. By the display system's repetition of the tuning process for different color intervals, CPⱼ, the present embodiment is advantageous in that compensation may be provided for one or more settings and/or properties of the screen of the display system, such as a non-linear color processing by the screen.

According to an embodiment of the present invention, the screen controller may be configured to control each sub-area of the plurality of sub-areas to display light based on static content. By the term “static content”, it is here meant content (e.g. an image) which is still, by which the light with the intensity, Iⱼ, and/or with the color, C_{i,j}, may be displayed.

According to an embodiment of the present invention, the screen controller may be configured to control each sub-area of the plurality of sub-areas to display light based on dynamic content. By the term “dynamic content”, it is here meant content which is dynamic, changing, moving, or the like, by which the light with the intensity, Iⱼ, and/or with the color, C_{i,j}, may be displayed.

According to an embodiment of the present invention, at least one of the intensity interval, IPⱼ, and the color interval, CPⱼ, may be based on at least one property of the screen. Hence, the screen may have one or more properties which may influence and/or affect the intensity interval, IPⱼ, and/or the color interval, CPⱼ. The present embodiment is advantageous in that the display system may display an intensity interval, IPⱼ, and/or a color interval, CPⱼ, which may be adapted for the screen property(ies), leading to an even further improved control by the controller of the set of light source(s) based on the user's first and second selections.

According to an embodiment of the present invention, the controller may be further configured to control the set of at least one light source based on the intensity, I_{i,j}, of the displayed light of the sub-area selected according to at least one previous first selection, and/or the color, C_{i,j}, of the displayed light of the sub-area selected according to at least one previous second selection. In other words, the controller may be configured to control the set of light source(s) based on one or more previous first and/or second selections by the user. The present embodiment is advantageous in that the controller may efficiently and conveniently display light with an intensity, I_{i,j}, and/or color, C_{i,j}, which may be particularly suitable for the user's matching selection. For example, if one or more previous (first and/or second) selections with the same or similar intensity(ies), I_{i,j}, and/or color(s), C_{i,j}, the display system may be configured to use this information for an improved operation/tuning.

According to an embodiment of the present invention, at least one set of the at least one set of at least one light source is arranged separately from the screen. Hence, one or more sets of light source(s) may be arranged (physically) separate from the screen. The present embodiment is advantageous in that the display system may achieve an improved lighting experience with the light source(s) of the display system being arranged at (different) distance(s) from the screen.

According to an embodiment of the present invention, at least one set of the at least one set of at least one light source is arranged on, at least one of, at least one edge of the screen, and a back side of the screen. Hence, one or more sets of light source(s) may be arranged on the screen edge(s) and/or on a back side of the screen. The present embodiment is advantageous in that the display system is relatively compact whilst achieving a desired lighting experience.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 is a schematic view of a display system according to an exemplifying embodiment of the present invention,

FIG. 2 is a schematic view of a control operation of the display system according to an exemplifying embodiment of the present invention,

FIGS. 3 and 4 are schematic views of operations of a display system according to embodiments of the present invention, and

FIG. 5 is a schematic flow chart diagram of a method according to an exemplifying embodiment of the present invention.

### DETAILED DESCRIPTION

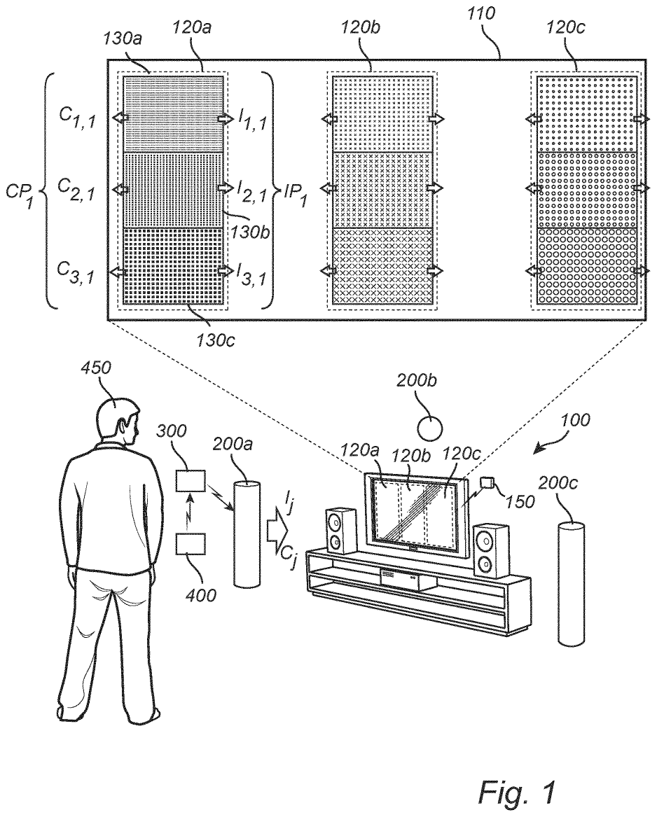

FIG. 1 is a schematic view of a display system 100 according to an exemplifying embodiment of the present invention. The display system 100 comprises a screen 110, which may be substantially any kind of screen or display, such as a TV screen, a computer screen, monitor, or the like. It should be noted that there may be a plurality of screens 110, but only a single screen 110 is shown in FIG. 1 for reasons of simplicity. The screen 110 comprises at least one screen part 120a-c, i.e. one or more parts or portions of the screen 110. Each screen part 120a-c comprises a plurality of sub-areas 130a-c, i.e. two or more parts or portions of the screen part 120a-c. For reasons of simplicity, only the sub-areas 130a-c of screen part 120a are indicated by references in FIG. 1. Furthermore, it will be appreciated that the number, position and/or size(s) of the screen parts 120a-c is (are) merely provided as an example.

The display system 100 comprises a (schematically indicated) screen controller 150 coupled to the screen 110. The screen controller 150 may be coupled to the screen 110 by wire or wirelessly. The display system 100 further comprises at least one set 200a-c of at least one light source arranged to emit light, wherein each set 200a-c of light source(s) is associated with a respective screen part 120a-c. Hence, the number of screen parts 120a-c and the number of sets 200a-c of light sources, is the same (exemplified as 3 in FIG. 1), wherein each set 200a-c of light sources is linked or associated with a respective screen part 120a-c. In FIG. 1, the sets 200a-c of light sources are all arranged separately from the screen 110. However, one or more of the sets 200a-c of light sources may alternatively be arranged on the edge of the screen 110 and/or a back side of the screen 110. According to yet another alternative, one or more of the sets 200a-c of light sources may be arranged further away from the edge of the screen 110. The sets 200a-c of light sources may comprise or constitute substantially any kind of luminaires, lighting devices, etc., and may, for example, comprise light-emitting diodes (LEDs).

The display system 100 further comprises a (schematically indicated) controller 300 coupled to the at least one light source 200a-c and configured to control the at least one light source 200a-c. The controller 300 may be coupled to the screen 110 by wire or wirelessly. The display system 100 further comprises a (schematically indicated) input 400. The input 400 is coupled to the controller 300 and is configured to receive information from a user 450. The input 400 may, for example, be or comprise a graphical user interface (GUI), a mobile phone, etc., by which the user 450 may provide the input 400.

For each screen part 120a-c of the screen 110, the screen controller 150 is configured to control each sub-area 130a-c of the plurality of sub-areas 130a-c to display light with a respective intensity, I_{i,j}, which may be within an intensity interval, IPⱼ (which, for example, may be based on one or more properties of the screen 110), wherein the respective intensity, I_{i,j}, may be different from an intensity of the displayed light of at least one other sub-area 130a-c of the screen part 120a-c. For example, as shown in FIG. 1, the (first) sub-area 130a is configured to display light with intensity, I_{1,1}, the (second) sub-area 130b is configured to display light with intensity, I_{2,1}, and the (third) sub-area 130c is configured to display light with intensity, I_{3,1}, wherein all intensities I_{1,1}, I_{2,1}, I_{3,1}, are within the intensity interval, IP₁. At least two of the intensities I_{1,1}, I_{2,1}, I_{3,1}, may be different from each other. For example, I_{1,1}≠I_{2,1}≠I_{3,1}. The controller 300 is configured to control the set(s) of light source(s) 200a-c associated with the screen part 120a-c such that the emitted light from the set of light source 200a-c has an intensity, Iⱼ. For example, the intensity, Iⱼ, may be within the intensity interval, IPⱼ. Hence, according to the example in FIG. 1, the controller 300 is configured to control e.g. the set of light sources 200a associated with the screen part 120a such that the emitted light from the set of light sources 200a has an intensity, I₁.

The input 400 is configured to receive information of a first selection from the user 450 of one sub-area 130a-c of the plurality of sub-areas 130a-c based on a level of correspondence/match between the displayed light of the sub-area 130a-c and the emitted light from the set of light sources 200a-c. Hence, according to the example in FIG. 1, if the user 450 finds that there is a match or correspondence between the displayed light of the (first) sub-area 130a and the emitted light from the set of light sources 200a with respect to intensity, the user 450 selects sub-area 130a and provides this information to the input 400. Alternatively, if the user 450 finds that there is a match or correspondence between the displayed light of the (second or third) sub-areas 130b, 130c and the emitted light from the set of light sources 200a with respect to intensity, the user 450 selects either the (second) sub-area 130b or the (third) sub-area 130c and provides this information to the input 400. The controller 300 is further configured to control the set of light sources 200a-c based on the intensity, I_{i,j}, of the displayed light of the sub-area 130a-c selected to the according to the first selection. Hence, according to the example in FIG. 1, and in case the user 450 has selected the (first) sub-area 130a, the controller 300 is configured to control the set of light sources 200a based on the intensity, I_{1,1}, of the displayed light of the sub-area 130a. Hence, the controller 300 may hereby tune the emitted light from the set of light sources 200a, such that the emitted light from the set of light sources 200a is tuned from intensity, Iⱼ, to an intensity based on the intensity, I_{1,1}, of the displayed light of the sub-area 130a.

The above-mentioned operation for the intensity is also performed for the color according to the display system 100. For each screen part 120a-c of the screen 110, the screen controller 150 is configured to control each sub-area 130a-c of the plurality of sub-areas 130a-c to display light in a respective color, C_{i,j}, which may be within a color interval, CPⱼ (which, for example, may be based on one or more properties of the screen 110), wherein the respective color, C_{i,j}, may be different from a color of the displayed light of at least one other sub-area 130a-c of the screen part 120a-c. For example, as shown in FIG. 1, the (first) sub-area 130a is configured to display light in a color, C_{1,1}, the (second) sub-area 130b is configured to display light in a color, C_{2,1}, and the (third) sub-area 130c is configured to display light in a color, C_{3,1}, wherein all colors, C_{1,1}, C_{2,1}, C_{3,1}, are within the color interval, CPi and wherein at least two od the colors, C_{1,1}, C_{2,1}, C_{3,1}, are different from each other. For example, C_{1,1}≠C_{2,1}, ≠C_{3,1}. The controller 300 is configured to control the set(s) of light source(s) 200a-c associated with the screen part 120a-c such that the emitted light from the set of light source 200a-c has a color, Cⱼ. For example, the color, Cⱼ, may be within the color interval, CPⱼ. Hence, according to the example in FIG. 1, the controller 300 is configured to control e.g. the set of light sources 200a associated with the screen part 120a such that the emitted light from set of light sources 200a has a color, C₁. The input 400 is configured to receive information of a second selection from the user 450 of one sub-area 130a-c of the plurality of sub-areas 130a-c based on a level of correspondence between the displayed light of the sub-area 130a-c and the emitted light from the set of light sources 200a-c. Hence, according to the example in FIG. 1, if the user 450 finds that there is a match or correspondence between the displayed light of the (first) sub-area 130a and the emitted light from the set of light sources 200a with respect to color, the user 450 selects sub-area 130a and provides this information to the input 400. Alternatively, if the user 450 finds that there is a match or correspondence between the displayed light of the (second or third) sub-areas 130b, 130c and the emitted light from the set of light sources 200a with respect to color, the user 450 selects either the (second) sub-area 130b or the (third) sub-area 130c and provides this information to the input 400. The controller 300 is further configured to control the set of light sources 200a-c based on the color, C_{i,j}, of the displayed light of the sub-area 130a-c selected to the according to the second selection. Hence, according to the example in FIG. 1, and in case the user 450 has selected the (first) sub-area 130a, the controller 300 is configured to control the set of light sources 200a based on the color, C_{1,1}, of the displayed light of the sub-area 130a. Hence, the controller 300 may hereby tune the emitted light from the set of light sources 200a, such that the emitted light from the set of light sources 200a is tuned from color, Cⱼ, to a color based on the color, C_{1,1}, of the displayed light of the sub-area 130a. The operation of the display system 100 for receiving the information input from the user 450 for intensity and/or color matching is furthermore repeated for each screen part 120a-c of the screen 110 and the associated set 200a-c of light sources.

The display system 100 hereby provides the possibility for the user/consumer 450 to select the sub-area 130a-c of the screen 110 which best matches the light from the associated set of light source 20a-c, leading to an improved experience of the user 450. In other words, the user 450 may choose an optimal (the best/preferred) match between the sub-areas 130a-c of the screen 110 and the associated light, and perform this for different light areas around the screen 110 corresponding to the respective screen parts 120a-c. Hence, for an optimal entertainment lighting experience, the display system 100 provides a tuning of the light effects so that the lighting color hue and/or intensity of the surrounding area around the screen 110 match the colour hue and/or intensity on the screen 110.

In FIG. 1, each sub-area 130a-c is associated with an identification label, ID_{L}=A, B, C, . . . , (not shown) wherein each identification label, ID_{L}, is arranged to be displayed on the respective sub-area 130a-c. Hence, the first selection of the sub-area 130a-c by the user 450 concerning intensity and/or the second selection of the sub-area 130a-c by the user 450 concerning color may be facilitated by the identification label, ID_{L}.

The screen controller 130 may be configured to control each sub-area 130a-c to display light based on static content, such as still image(s), by which the light with the intensity, Iⱼ, and/or with the color, C_{i,j}, may be displayed. Alternatively, the screen controller 130 may be configured to control each sub-area 130a-c to display light based on dynamic content, such as dynamic, changing and/or moving images or videos.

It will be appreciated that the screen controller 150 in FIG. 1 may be configured to simultaneously control each sub-area 130a-c to display light with at least one of the respective intensity, I_{i,j}, and the color, C_{i,j}. Hence, the screen controller 150 may display light in all of the sub-areas 130a-c at once such that the user 450 may make the first and second selections based on the level of correspondence between the displayed light of the sub-area 130a-c and the emitted light from the set of light source(s) 200a-c when being displayed all screen parts 120a-c. Alternatively, the screen controller 150 may be configured to control each sub-area 130a-c to display light with at least one of the respective intensity, I_{i,j}, and the color, C_{i,j}, in sequence. Hence, the screen controller 150 may, according to this alternative, display light e.g. for sub-area 130a, followed by sub-area 130b, and thereafter sub-area 130c.

According to an example, the controller 300 may further be configured to control the set 200a-c of light sources based on the intensity, I_{i,j}, of the displayed light of the sub-area 130a-c selected according to at least one previous first selection by the user, and/or the color, C_{i,j}, of the displayed light of the sub-area 130a-c selected according to at least one previous second selection by the user.

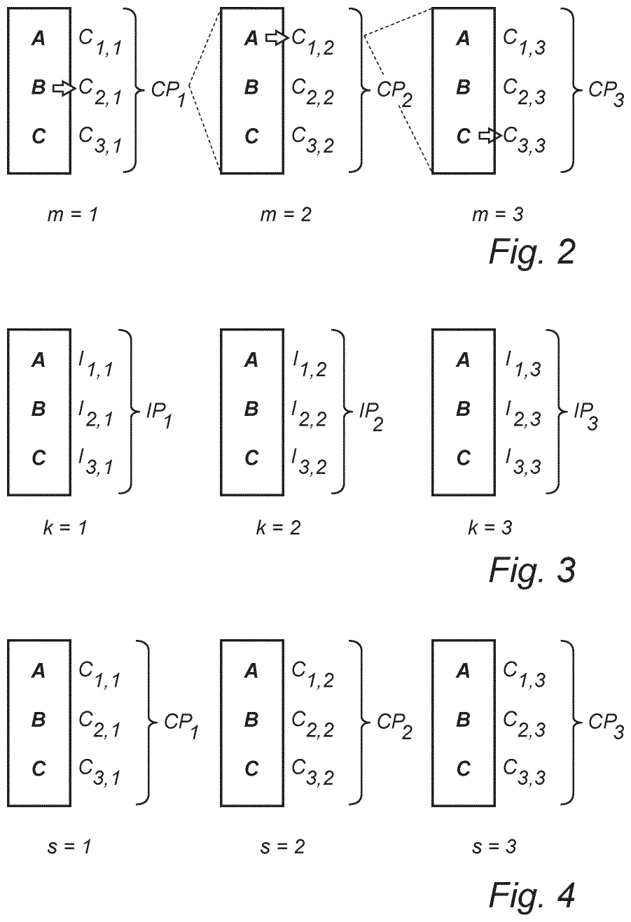

FIG. 2 is a schematic view of a control operation of the display system 100 according to an exemplifying embodiment of the present invention, and it is referred to FIG. 1 and the associated text for an increased understanding of the display system 100 and for numerical references. According to this example, the screen controller 150 may be further configured to perform its control iteratively. The iterative control may be performed for a plurality of iterations m=1 . . . p, wherein p is an integer. According to the example of FIG. 2, p=3, i.e. the control is performed according to the example described in FIG. 1 and the associated text (for m=1), whereas the (two) following iterations are performed for m=2 and m=3. Hence, for the initial step m=1, a user may have performed a (second) selection of sub-area 130b of the plurality of sub-areas 130a-c based on a level of correspondence (matching) between the displayed light of the sub-area 130b and the emitted light from the set 200a of light sources, whereby the controller is configured to control the set 200a of light sources based on the color, C_{2,1}, of the displayed light of the sub-area 130b selected according to the second selection. The screen controller 150 may thereby control the sub-areas 130a-c to display light in a (new) color, Cⱼ, within a (new) color interval, CPⱼ, dependent on the preceding (m=1) second selection wherein the respective color, Cⱼ, is different from a color of the displayed light of at least one other sub-area of the screen part. For example, for iteration m=2, the (new) color interval, CP₂, may represent the preceding color, C_{2,1}, and may be divided into new colors C_{1,2}, C_{2,2}, C_{3,2}. Iteratively, the user may hereby make a (second) selection of e.g. sub-area 130a, which again, for iteration m=3, may result in that (new) color interval, CP₃, may represent the preceding color, C_{1,2}, and may be divided into new colors C_{1,3}, C_{2,3}, C_{3,3}. Then, the controller is further configured to control the set of at least one light source based on the color, C_{i,j}, of the displayed light of the sub-area selected according to the p^{th} second selection. Hence, for the (final) iteration m=p=3, the input may be configured to receive information of a second selection of one sub-area by the user, and the controller may further be configured to control the set of light source(s) based on the color, C_{i,j} (here exemplified as C_{3,3}) of the displayed light of the sub-area selected according to the second selection.

FIG. 3 is a schematic view of an operation of a display system 100 according to an embodiment of the present invention, and it is referred to FIG. 1 and the associated text for an increased understanding of the display system 100 and for numerical references. For a plurality of iterations k=1 . . . n, wherein n is an integer, the screen controller is further configured to control each sub-area of the plurality of sub-areas to display light with a respective intensity, I_{i,j}, within a k^{th} intensity interval, IPⱼ, wherein the respective intensity, I_{i,j}, is different from an intensity of the displayed light of at least one other sub-area of the screen part, the controller being configured to control the set of at least one light source associated with the screen part such that the emitted light from the set of at least one light source has a k^{th} intensity, Iⱼ. Hence, according to the example described in FIG. 1 and the associated text (for k=1), which also is shown in the leftmost part of FIG. 3, the (first) sub-area 130a is configured to display light with intensity, I_{1,1}, the (second) sub-area 130b is configured to display light with intensity, I_{2,1}, and the (third) sub-area 130c is configured to display light with intensity, I_{3,1}, wherein all intensities I_{i,j}, I_{2,1}, I_{3,1}, are within the intensity interval, IP₁ and wherein I_{1,1}≠I_{2,1},≠I_{3,1}. The display system is configured to continue this iterative loop in case no first selection is made by the user, i.e. for k=2 and k=3, the (first) sub-area 130a is configured to display light with intensity, I_{1,2}, and I_{1,3}, respectively, the (second) sub-area 130b is configured to display light with intensity, I_{2,2}, and I_{2,3}, respectively, and the (third) sub-area 130c is configured to display light with intensity, I_{3,2}, and I_{3,2}, respectively, wherein all intensities I_{1,2}, I_{2,2}, I_{3,2}, are within the intensity interval, IP₂, and wherein, for example, I_{1,2}≠I_{2,2}, ≠I_{3,2}, and all intensities I_{1,3}, I_{2,3}, I_{3,3}, are within the intensity interval, IP₃ and wherein, for example, I_{1,3}≠I_{2,3},≠I_{3,3}. It will be appreciated that the display system is configured to interrupt (break) the loop in case the user makes a first selection concerning intensity of one sub-area based on a level of correspondence between the displayed light of the sub-area and the emitted light from the set of light source(s), and whereby the controller accordingly is configured to control the set of light source(s) based on the intensity, I_{i,j}, of the displayed light of the sub-area selected according to the first selection.

FIG. 4 is a schematic view of an operation of a display system 100 according to an embodiment of the present invention, and it is referred to FIG. 1 and the associated text for an increased understanding of the display system 100 and for numerical references. For a plurality of iterations s=1 . . . t, wherein t is an integer, the screen controller is further configured to control each sub-area of the plurality of sub-areas to display light in a color, C_{i,j} within a s^{th} color interval, CPⱼ, wherein the respective color, C_{i,j}, is different from a color of the displayed light of at least one other sub-area of the screen part, the controller being configured to control the set of at least one light source associated with the screen part such that the emitted light from the set of at least one light source has a s^{th} color, Cⱼ. Hence, according to the example described in FIG. 1 and the associated text (for s=1), which also is shown in the leftmost part of FIG. 4, the (first) sub-area 130a is configured to display light in a color, C_{1,1}, the (second) sub-area 130b is configured to display light in a color, C_{2,1}, and the (third) sub-area 130c is configured to display light in a color, C_{3,1}, wherein all colors C_{1,1}, C_{2,1}, C_{3,1}, are within the color interval, CPi and wherein C_{1,1}≠C_{2,1}, ≠C_{3,1}. The display system is configured to continue this iterative loop in case no first selection is made by the user, i.e. for s=2 and s=3, the (first) sub-area 130a is configured to display light in a color, C_{1,2}, and C_{1,3}, respectively, the (second) sub-area 130b is configured to display light in a color, C_{2,2}, and C_{2,3}, respectively, and the (third) sub-area 130c is configured to display light in a color, C_{3,2}, and C_{3,2}, respectively, wherein all colors C_{1,2}, C_{2,2}, C_{3,2}, are within the color interval, CP₂, and wherein, for example, C_{1,2}≠C_{2,2},≠C_{3,2}, and all colors C_{1,3}, C_{2,3}, C_{3,3}, are within the color interval, CP₃ and wherein, for example, C_{1,3}≠C_{2,3},≠C_{3,3}. It will be appreciated that the display system is configured to interrupt (break) the loop in case the user makes a second selection regarding color of one sub-area based on a level of correspondence between the displayed light of the sub-area and the emitted light from the set of light source(s), and whereby the controller accordingly is configured to control the set of light source(s) based on the color, C_{i,j}, of the displayed light of the sub-area selected according to the second selection.

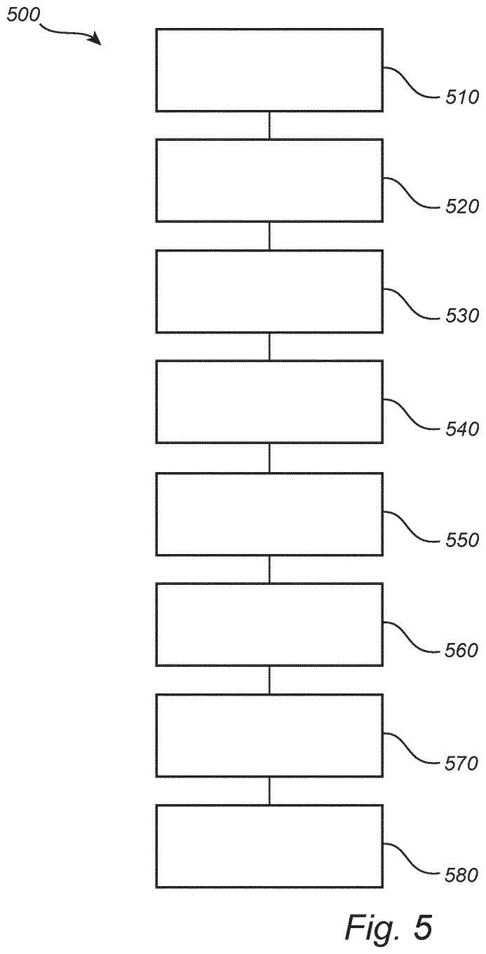

FIG. 5 is a schematic flow chart diagram of a method 500 for light source control via a display system according to the first aspect of the present invention. The display system comprises a screen comprising at least one screen part, wherein each screen part comprises a plurality of sub-areas, at least one light source arranged to emit light, wherein the at least one light source is associated with the at least one screen part. The method 500 comprises the step of controlling 510 each sub-area of the plurality of sub-areas to display light with a respective intensity, I_{i,j}, which may be within an intensity interval, IPⱼ, wherein the respective intensity, I_{i,j}, may be different from an intensity of the displayed light of at least one other sub-area of the screen part. The method 500 further comprises the step of controlling 520 the at least one light source associated with the screen part such that the emitted light from the at least one light source has an intensity, Iⱼ. The method 500 further comprises the step of receiving 530 information from a user of a first selection of one sub-area of the plurality of sub-areas based on a level of correspondence between the displayed light of the sub-area and the emitted light from the set of at least one light source. The method 500 further comprises the step of controlling 550 each sub-area of the plurality of sub-areas to display light in a color, C_{i,j}, which may be within a color interval, CPⱼ, wherein the respective color, C_{i,j}, may be different from a color of the displayed light of at least one other sub-area of the screen part. The method 500 further comprises the step of controlling 560 the at least one light source associated with the screen part such that the emitted light from the at least one light source has a color, Cⱼ. The method 500 further comprises the step of receiving 570 information from a user of a second selection of one sub-area of the plurality of sub-areas based on a level of correspondence between the displayed light of the sub-area and the emitted light from the set of at least one light source. The method 500 further comprises the step of subsequently controlling 540,580 the at least one light source based on the intensity, I_{i,j}, of the displayed light of the sub-area selected according to the first selection, and/or on the color, C_{i,j}, of the displayed light of the sub-area selected according to the second selection.

The person skilled in the art realizes that the present invention by no means is limited to the preferred embodiments described above. On the contrary, many modifications and variations are possible within the scope of the appended claims. For example, it will be appreciated that the figures are merely schematic views of a display system 100 according to embodiments of the present invention. Hence, any elements/components of the display system 100 such as the number of screen parts 120a-c, the number of sub-areas 130a-c, set(s) 200a-c of light source(s), etc., may vary in number and/or have different dimensions, shapes and/or sizes than those depicted and/or described.

1. A display system, comprising
a screen controller coupled screen comprising at least one screen part, wherein the at least one screen part comprises a plurality of sub-areas,
at least one light source arranged to emit light, wherein the at least one light source is associated with the at least one screen part,
a controller configured to control the at least one light source, and
an input coupled to the controller and configured to receive information from a user,
wherein the screen controller is configured to control each sub-area of the plurality of sub-areas to display light having a respective intensity, Ii,j, and/or a respective color, Ci,j, wherein the respective intensity Ii,j and/or the respective color, Ci,j is different from an intensity and/or a color of the displayed light of at least one other sub-area of the screen part,
wherein the controller is configured to control the at least one light source associated with the at least one screen part such that the emitted light from the at least one light source has an intensity, Ij, and/or a color, Cj,
wherein the input is configured to receive information of a first selection from the user of one sub-area of the plurality of sub-areas based on a level of matching between the intensity of the displayed light of the one sub-area and the intensity of the emitted light from the at least one light source, and/or of a second selection from the user of one sub-area of the plurality of sub-areas based on a level of matching between the color of the displayed light of the one sub-area and the color of the emitted light from the at least one light source, and
wherein the controller is further configured to subsequently control the at least one light source based on the intensity, Ii,j, of the displayed light of the sub-area selected according to the first selection from the user and/or the color, Ci,j, of the displayed light of the sub-area selected according to the second selection from the user.

2. (canceled)

3. Display system according to claim 1, wherein each sub-area of the plurality of sub-areas is associated with an identification label, ID_{L}, wherein each identification label, ID_{L}, is arranged to be displayed on the respective sub-area.

4. Display system according to claim 1, wherein the screen controller is configured to simultaneously control each sub-area of the plurality of sub-areas to display light with at least one of the respective intensity, I_{i,j}, and the color, C_{i,j}.

5. Display system according to claim 1, wherein the screen controller is configured to control each sub-area of the plurality of sub-areas to display light with at least one of the respective intensity, I_{i,j}, and the color, C_{i,j}, in sequence.

6. Display system according to claim 1, wherein the screen controller is further configured to, for a plurality of iterations m=1 . . . p, wherein p is an integer ≥1,
control each sub-area of the plurality of sub-areas to display light in a color, C_{i,j}, within a color interval, CPⱼ, dependent on the preceding second selection wherein the respective color, C_{i,j}, is different from a color of the displayed light of at least one other sub-area of the screen part,
wherein the controller is further configured to control the set of at least one light source based on the color, C_{i,j}, of the displayed light of the sub-area selected according to the p^{th} second selection.

7. Display system according to claim 1, wherein the screen controller is further configured to, for a plurality of iterations k=1 . . . n, wherein n is an integer ≥1,
control each sub-area of the plurality of sub-areas to display light with a respective intensity, I_{i,j}, within a k^{th} intensity interval, IPᵢ, wherein the respective intensity, I_{i,j}, is different from an intensity of the displayed light of at least one other sub-area of the screen part,
the controller being configured to control the set of at least one light source associated with the screen part such that the emitted light from the set of at least one light source has a k^{th} intensity, Iⱼ.

8. Display system according to claim 1, wherein the screen controller is further configured to, for a plurality of iterations s=1 . . . t, wherein t is an integer ≥1,
control each sub-area of the plurality of sub-areas to display light in a color, C_{i,j} within a s^{th} color interval, CPⱼ, wherein the respective color, C_{i,j}, is different from a color of the displayed light of at least one other sub-area of the screen part,
the controller being configured to control the set of at least one light source associated with the screen part such that the emitted light from the set of at least one light source has a s^{th} color, Cⱼ.

9. Display system according to claim 1, wherein the screen controller is configured to control each sub-area of the plurality of sub-areas to display light based on static content.

10. Display system according to claim 1, wherein the screen controller is configured to control each sub-area of the plurality of sub-areas to display light based on dynamic content.

11. Display system according to claim 1, wherein the screen controller is configured to control each sub-area of the plurality of sub-areas to display light with a respective intensity Ii,j, within an intensity interval Ipi, and/r to display light in a color, Ci,j, within a color interval CPi, wherein at least one of the intensity interval, IPⱼ, and the color interval, CPⱼ, is based on at least one property of the screen.

12. Display system according to claim 1, wherein the at least one light source is arranged separately from the screen.

13. Display system according to claim 1, wherein the at least one light source is arranged on, at least one of,
at least one edge of the screen, and
a back side of the screen.

14. Method for light source control via a display system comprising a screen comprising at least one screen part, wherein the at least one screen part comprises a plurality of sub-areas, at least one light source arranged to emit light, wherein the at least one light source is associated with the at least one screen part, wherein the method comprises,
controlling each sub-area of the plurality of sub-areas to display light with a respective intensity, I_{i,j}, and/or controlling each sub-area of the plurality of sub-areas to display light in a color, C_{i,j}, wherein the respective intensity, li and/or the respective color, Ci,j, is different from an intensity and/or a color of the displayed light of at least one other sub-area of the screen part,
controlling the at least one light source associated with the screen part such that the emitted light from the set of at least one light source has an intensity, Iⱼ, and/or a color, Cⱼ,
receiving information from a user of a first selection of one sub-area of the plurality of sub-areas based on a level of matching between the displayed light of the one sub-area and the emitted light from the at least one light source, and/or
receiving information from a user of a second selection of one sub-area of the plurality of sub-areas based on a level of matching between the displayed light of the one sub-area and the emitted light from the set of at least one light source,
subsequently controlling the at least one light source based on the intensity, I_{i,j}, of the displayed light of the sub-area selected according to the first selection from the user, and/or based on the color, C_{i,j}, of the displayed light of the sub-area selected according to the second selection from the user.

15. A computer program product for a computing device, the computer program product comprising computer program code to perform the method of claim 14 when the computer program product is run on a processing unit of the computing device.

16. Display system according to claim 1, wherein the controller is further configured to control the set of at least one light source based on
the intensity, Ii,j, of the displayed light of the sub-area according to at least one previous first selection, and
the color, Ci,j, of the displayed light of the sub-area selected according to at least one previous second selection.
